(19) United States
(12) Patent Application Publication
(10) Pub. No.: US 2024/0215144 A1
(43) Pub. Date: Jun. 27, 2024

(54) PLASMA CYCLONE REACTOR

(71) Applicant: SALTX TECHNOLOGY AB, HÄGERSTEN (SE)

(72) Inventors: Corey BLACKMAN, Lidingö (SE); Lars CROON, Stockholm (SE); Boo LJUNGDAHL, Karlskoga (SE)

(21) Appl. No.: 18/288,349

(22) PCT Filed: Apr. 26, 2022
(86) PCT No.: PCT/EP2022/061061

§ 371 Date: Oct. 25, 2023

(30) Foreign Application Priority Data
Apr. 28, 2021 (SE) 2150543-3

(51) Int. Cl. H05H 1/34

(52) U.S. Cl. CPC H05H 1/3478; H05H 1/3468

(57) ABSTRACT

There is provided a reactor wherein the reactor is a cyclone reactor, and wherein at least one volume (Vh) inside the reactor is adapted to be heated by a plasma torch to a temperature of at least 3000° C. Advantages include that the calcination is quicker with a more uniform heat transfer to all particles. The calciner can be made more compact. The temperature difference in the process ΔT increases, which also improves the efficiency of the process. The calcination process can be made essentially kinetically controlled. The elevated temperatures of the heat treated material reduce recombination reactions.

### TECHNICAL FIELD

The present disclosure relates to a cyclone reactor with a high temperature zone as well as a method for heat treating various materials.

### BACKGROUND

Calcination of limestone is a well-known process that has been known for millennia.

US 20120141354 discloses a method to separate CO₂ gas generated in a cement-manufacturing facility in a high concentration and recover the CO₂ gas. The method includes feeding a cement material before calcination and a heat medium which has a particle diameter larger than that of the cement material and has been heated to the calcination temperature or higher in a medium-heating furnace, to a mixing calciner and recovering the CO₂ gas generated by the calcination of the cement material. The heat medium circulates between the medium-heating furnace and the mixing calciner. One aspect of the present invention includes feeding a cement material before calcination to a regenerative calciner which has been heated to the calcination temperature or higher and has stored heat therein; and recovering the CO₂ gas generated by the calcination of the cement material.

US 20140334996 discloses a process for producing a usable product in a reactor comprising introducing co-reactants comprising a fuel source and oxygen into a first section through an inlet, the fuel source comprising carbon; combusting at least a portion of the fuel source and oxygen in an exothermic reaction in the first section using a burner; transferring the co-reactants through a second section that includes a throat having a size that is smaller than a size of the first section, such that a vacuum is induced and a velocity of the co-reactants increases; transferring the co-reactants into a third section that is downstream from the throat and includes an inner wall having a size that is greater than the size of the throat; depositing at least a portion of the uncombusted carbon and a metal oxide along the inner wall, wherein the metal oxide is introduced into at least one of the sections; converting the deposited metal oxide into the usable product in a carbothermic reduction reaction within a molten slag along the inner wall at a temperature of at least 1600° C.

U.S. Pat. No. 4,152,169 discloses calcination in plasma, where the plasma torch rotates. Cyclones are utilized for preheating and subsequent separation, but not in the calcination reactor.

WO 02/096821 discloses a method for calcination with a plasma of carbon dioxide. There is a plasma generator as a separate stage before the calcination reactor. The carbon dioxide gas plasma has a temperature of 3000-4000° C. at the discharge of the plasma generator. The lime raw material is mixed with the hot gas from the plasma generator, i.e., the heat transfer is mainly from the hot gas exiting from the plasma generator. A cyclone is shown in a subsequent step after the calcination reactor. The calcination is not carried out in a cyclone reactor.

WO 2020/232091 discloses calcination where recirculation of gases is utilized. A calcination cyclone stage is disclosed. There is envisaged preheating and heating. The carbon dioxide gas in the calcining loop may be heated up to 2000° C. by an electrical heater. The electrical heater may produce heat via inductive, resistance, infrared, microwave, plasma, or any type based on electrical power. It is clear that the calciner can provide a temperature up to 2000° C. and that this temperature is an upper limit.

US 20120263640 discloses a cyclone reactor for producing a usable by-product as part of a recoverable slag layer, the reactor comprising a housing having an outer wall that defines a combustion chamber; an inlet configured to introduce a reactant into the reactor; a burner configured to combust the reactant in a flame zone near a central axis of the chamber; and an outlet configured to provide for the removal of the usable by-product from the housing; wherein the reactor is configured to combust a first portion of the reactant in an exothermic reaction in the flame zone; and wherein the reactor is configured to convert a second portion of the reactant in an endothermic reaction near the outer wall to produce the by-product as part of the slag layer.

Even though at least some calcination processes according to the state of the art are successfully used today, there is still room for an improvement with regard to their efficiency and performance.

### SUMMARY OF INVENTION

It is an object of the present disclosure to alleviate at least some of the problems in the prior art and to provide an improved heat treatment method as well as a device for carrying out the method.

The inventors have realized that advantages can be obtained by carrying out heat treatment in a cyclone reactor and simultaneously provide at least one high temperature volume Vₕ in the reactor, where the temperature is at least 3000° C. The high temperature volume Vₕ is a zone in the reactor where the temperature is very high such as at least 3000° C. In reactors according to the art the heat energy is transferred to the material to be calcined by thermal conduction (at least to some degree), by thermal convection, and by thermal radiation. The inventors have discovered that a more efficient heating of the particles of material to be heat treated can be obtained if the fraction of energy transferred by thermal radiation is increased. In particular, this is true for a cyclone reactor, which is compact with a low volume, which gives a short distance between the hot high temperature zone and the particles to be heat treated. The high temperature zone with its high temperature gives a higher fraction of heat transfer by thermal radiation, which in combination with the compactness of the cyclone reactor gives a very efficient heat transfer to the particles. In the cyclone, the particles swirl around the volume Vₕ with high temperature and are thereby heated by thermal radiation.

The result is a quicker heating as well as a more uniform heat transfer to all particles. The fraction of particles, which are not heated immediately in the cyclone, is minimized.

Further the temperature difference in the process ΔT increases, which also improves the efficiency of the process. Additionally, the elevated temperature of the material leaving the cyclone reactor minimizes spontaneous recombination of the heat treated products. As an example for calcination of CaCO₃ the newly formed Cao, does not to any disturbing extent, react with released CO₂ to form CaCO₃ before the released CO₂ has been separated from the formed CaO.

Thus, the efficiency is improved, the speed of the calcination can be increased, and the reactor can be made compact.

According to a first aspect there is provided a reactor wherein the reactor is a cyclone reactor, and wherein at least one volume (Vₕ) inside the reactor is adapted to be heated by a plasma torch to a temperature of at least 3000° C.

According to a second aspect there is provided a heat treatment method, wherein a material is heat treated in a reactor, wherein the reactor is a cyclone reactor, wherein at least one volume (Vₕ) inside the reactor is heated by a plasma torch to a temperature of at least 3000° C., and wherein heat is transferred from the at least one volume (Vₕ) to the material by at least thermal radiation.

Further embodiments are defined in the appended dependent claims.

### BRIEF DESCRIPTION OF THE DRAWINGS

Aspects and embodiments will be described with reference to the following drawings in which:

FIG. 1 shows a simplified side view of a reactor, which is a cyclone. At least one volume (Vₕ) adapted to be heated by a plasma torch to a temperature of at least 3000° C. is in this particular embodiment in the middle of the uppermost part L1. The material is fed pneumatically into the cyclone from the side through a pipe, which is not shown.

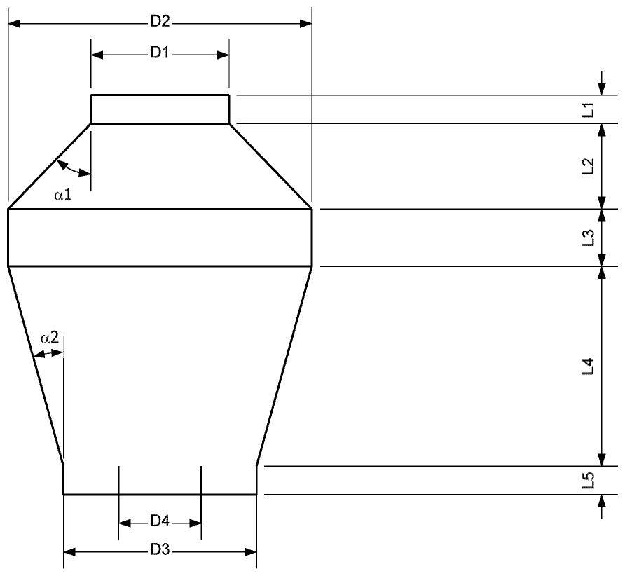

### DETAILED DESCRIPTION OF THE INVENTION

Before the invention is disclosed and described in detail, it is to be understood that this invention is not limited to particular compounds, configurations, method steps, substrates, and materials disclosed herein as such compounds, configurations, method steps, substrates, and materials may vary somewhat. It is also to be understood that the terminology employed herein is used for the purpose of describing particular embodiments only and is not intended to be limiting since the scope of the present invention is limited only by the appended claims and equivalents thereof.

It must be noted that, as used in this specification and the appended claims, the singular forms “a”, “an” and “the” include plural referents unless the context clearly dictates otherwise.

If nothing else is defined, any terms and scientific terminology used herein are intended to have the meanings commonly understood by those of skill in the art to which this invention pertains.

The term “calcination” as used herein refers inter alia to treatment of limestone (CaCO₃) to yield calcium oxide (CaO). As used herein the term calcination also encompasses thermal treatment of a solid in absence or limited supply of air or oxygen. Further treatment of MgCO₃ to yield MgO and treatment of Ca(OH)₂ to yield CaO are also encompassed.

The term “cyclone” as used herein refers to a cyclone reactor where a rotating gas flow is established inside a cylindrical or conical reactor, which is called a cyclone reactor. The gas including solid material flows in a helical pattern inside the cyclone reactor. Typically, the flow begins at the top of the cyclone reactor and typically, the flow ends at the bottom of the cyclone reactor where it exits.

The term “heating” as used herein refers to a process where energy is transferred to a material so that its temperature increases.

The term “sintering” as used herein refers to a process where pieces of solid material is forming a solid mass by heat without melting the material to liquefaction. The atoms in the material diffuse across the boundaries of the particles, fusing the particles together and creating one solid piece. The sintering temperature does typically not reach the melting point of the material.

The term “plasma” as used herein refers to a fundamental state of matter and is generally described as a gas of ions and free electrons.

In the first aspect there is provided a reactor wherein the reactor is a cyclone reactor, and wherein at least one volume (Vₕ) inside the reactor is adapted to be heated by a plasma torch to a temperature of at least 3000° C.

The volume (Vₕ) is In one embodiment, centred in the cyclone reactor. In one embodiment, the volume (Vₕ) is in the centre of the vortex of the cyclone, which is intended to be created when the reactor operates. The centre of the vortex during operation is the same as the centre of the cyclone for a typical cyclone with a circular crosscut. The cyclone is adapted so that the material swirls around the volume (Vₕ) in the cyclone reactor during operation.

The material to treat in the calciner is In one embodiment, CaCO₃ (s). In another embodiment, the material is MgCO₃ (s). In yet another embodiment the material is Ca(OH)₂. Alternatively, the material to be treated in the calciner is a mixture comprising at least one of CaCO₃ (s) and MgCO₃. Often CaCO₃ (s) is in the form of calcite having a relatively low melting temperature (1339° C.). However, the CaCO₃ (s) will at normal pressures decompose to CaO at lower temperatures than the melting temperature.

The CaO (s) has a much higher melting temperature (2613° C.). However, the structure of the particle will change at elevated temperature due to phase changes of Cao and impurities. This phenomenon is recognized as “dead burning” when the temperature is excessively high. Thus, too high temperatures are generally to be avoided unless these phase changes are desired.

The material to be treated in the reactor can additionally be heated to temperatures so as to elicit melting, sintering, or other heat induced reactions and/or phase changes.

The material to be heat treated is provided in the form of particles. If the heat transfer into the interior of the particle and the diffusion resistance of CO₂ leaving the particle is of much less importance than the rate of the calcination reaction, the overall reaction is said to be kinetically controlled. Not too large particles are suitable so that the reaction rate is kinetically controlled. A particle size in the range 10-1000 μm is suitable. The average particle size is determined as follows. The particle size distribution is measured by laser diffraction according to ISO 13320:2020. Then the average particle size is calculated from the measured particle size distribution as described in ISO 9276-2:2014 using the moment notation. Thus, in one embodiment, the material to be heat treated is provided as particles with an 10 to 1000 μm, wherein the average particle size is calculated according to ISO 9276-2:2014 using the moment notation starting from a particle size distribution measured according to ISO 13320:2020.

The particles are typically carried in a flow of gas when they enter the reactor. The gas is In one embodiment, a mixture of gases. In one embodiment, the mixture of gases comprises CO₂. In one embodiment, the mixture of gases comprises air. In one embodiment, the gas is superheated steam. In one embodiment, the plasma comprises at least one selected from the group consisting of carbon dioxide, air and superheated steam.

The residence time in the cyclone reactor is typically in the range of 0.2-60 seconds depending on the desired temperature of the particles and other factors. A typical temperature for the particles in the cyclone reactor is in the range 800-1450° C. I.e., the particles reach this temperature after heating. A particle temperature around 1000° C. is utilized in one embodiment. The short residence time in the reactor near the volume Vₕ with high temperature gives a heating to the suitable temperature. The residence time in the cyclone reactor is adapted so that the particles are heated to a suitable temperature for the calcination reaction to occur. The residence time and the temperature of the particles leaving the calciner are such that the heat-treated material does not undergo chemical recombination with the gas, at least not to any extent which has negative impact on the process. In the prior art it can be a problem that the newly heat-treated material recombines with the released gas. The problem is minimized by keeping the temperature sufficiently high until the reaction products, i.e., the heat-treated material and the released gas are separated from each other. Also a short processing time will decrease the problem with recombination.

The particles are typically preheated before they are fed to the cyclone reactor.

The volume Vₕ in the cyclone reactor with high temperature is heated with a plasma torch. In one embodiment, the plasma torch comprises an internal electrode, an output electrode, and an insulator between the electrodes, through which the working gas enters the plasma torch. The electric arc is ignited between the two electrodes. Some of the working gas penetrates the arc column while the remaining gas flows between the arc and the wall. The working gas flow, which penetrates the arc column, reaches the temperature of the arc through Joule heating. Joule heating, also known as Ohmic or resistive heating, is described as the heat generated when an electric current pass through a resistance. The gas is ionized and becomes electrically conductive. The rest of the working gas is not heated much since there is no convective heat exchange with the arc due to a thermal boundary layer “blocking” the heat exchange. Where the wall and thermal boundary layers come together, called the shunting zone, the arc and the main gas flow starts interacting, creating intense mixing of the hot and cold gas flows. This results in a plasma flow with a high-temperature core and rapidly decreasing temperature profile in radial direction forming at the exit of the plasma torch. Typically, less than half of the flow participates in the arc discharge and reaches the plasma state, but it is enough to create and maintain the heating element. The remainder of the gas is heated by the plasma via all three mechanisms of heat transfer (conduction, convection, and radiation). Water-cooling of the output electrode is In one embodiment, used to minimize the rate of vaporization of electrode materials due to very high temperatures.

The plasma temperature is held at 3000° C. or more. Working gas temperature at inlet to the plasma torch is In one embodiment, limited to 100-150° C., but could also be higher.

In an embodiment where CO₂ is in the plasma torch, hot gases with high energy density are generated by a CO₂-plasma torch. The energy density in such a CO₂-plasma torch is about 7.5 MJ/kg in a ˜3000-3500° C. torch (with partly dissociated CO₂). The plasma torch is In one embodiment, introduced vertically at the top of the calciner and centered towards the center of the cyclone calciner as seen from the top of the calciner.

The material to be heat treated is In one embodiment, pneumatically conveyed and tangentially introduced into the plasma calciner periphery. In one embodiment, the material to be heat treated is fed together with additional CO₂. In one embodiment, the CO₂ flow is preheated. The material to be heat treated is In one embodiment, preheated. In one embodiment, the material to be heat treated is preheated to a temperature in the interval 750-950° C.

When the material in particle form to be heat treated enters the cyclone calciner, heat is transferred quickly to the particles, partly by thermal radiation but also by mixing and convection. The part of heat transferred by thermal radiation is increased compared to the lower temperatures according to the prior art. This leads to an efficient and rapid calcination and release of additional CO₂.

The reaction is strongly endothermic, and rapidly lowers the average temperature of the particles along the flow of material in the calciner. At the outlet, where both gas and particles are well mixed, the average temperature is typically around 1000-1300° C., which is a suitable temperature for calcination.

In one embodiment, the reactor is equipped with at least one outlet in the lower half of the reactor, and the reactor is adapted so that the average temperature of the mixture of gas and particles in the outlet is not more than 1300° C. In one embodiment, of the heat treatment method, the material is allowed to be cooled to a temperature of not more than 1000° C. at an outlet of the reactor. The material is cooled by letting it be in the lower part of the reactor where the distance from at least one volume (Vₕ) is greater so that the material is not heated to such a large extent. By having a longer dwell time in the reactor the temperature at the exit of the reactor is lowered and it has been discovered that this has a positive influence on the calcination.

In one embodiment, at least one volume (Vₕ) is in the uppermost part of the reactor, wherein uppermost is in relation to the direction of gravity force. In a typical embodiment, the material to be heat treated enters the reactor in the top or at least the uppermost part. The material then follows the whirl created inside the cyclone reactor. While the material is in the uppermost part it will be close to the at least one volume (Vₕ) where the temperature is high and there it will be efficiently exposed to thermal radiation. The temperature is so high and due to the choice of a cyclone reactor, the material to be heat treated will be close to the volume (Vₕ) for a short while sufficient for the calcination so that an efficient and quick calcination is ensured. The particles to be heat treated are close to the volume Vₕ for a period of time to reach a suitable temperature for the calcination reaction to occur. The material to be heat treated will flow along the periphery of the cyclone entering from one or several inlets. The flow of particles in a gas flow will form a helical and/or circular gas film in the cyclone. The helical and/or circular flow will allow better control of the process. In one embodiment, the cyclone reactor comprises means to direct the flow of gas and particles. Example of such means include but are not limited to flanges and vanes inside the cyclone reactor.

In one embodiment, the volume (Vₕ) is centered in the cyclone reactor as seen from above and the whirl intended to be created in the cyclone reactor is also centered in the cyclone reactor as seen from above.

All directions such as up, down, side, uppermost, lowermost, and so on are in relation to the intended position of the calciner during operation and in relation to the gravitational force so that down has the same direction as the gravitational force.

In one embodiment, the reactor is equipped with at least one inlet in the upper half of the reactor, and which inlet is directed tangentially in a circular cross section of the reactor. The cyclone reactor is equipped with at least one inlet directed to create a cyclone of gas and particles inside the reactor. Typically, at least one inlet is in the upper part of the reactor.

In one embodiment, the lower part of the reactor is tapered towards the lowermost part. In such an embodiment, the reactor is conical and narrower towards the bottom.

In one embodiment, at least one volume (Vₕ) inside the reactor is adapted to be heated by a plasma torch to a temperature of at least 3500° C.

It should be noted that the high temperature at least 3000° C. only applies to the at least one volume (Vₕ) inside the reactor and it does not mean that all material inside the reactor is heated to this temperature. Typically, the residence time inside the reactor for the material to be heat treated is so short that this high temperature of 3000° C. is not reached and instead a temperature sufficient for efficient calcination is reached.

In one embodiment, at least one volume (Vₕ) inside the reactor is heated by the plasma torch to a temperature of at least 3250° C. In one embodiment, at least one volume (Vₕ) inside the reactor is heated by the plasma torch to a temperature in the range 3000-4000° C. In another embodiment at least one volume (Vₕ) inside the reactor is heated by the plasma torch to a temperature in the range 3500-4500° C.

When designing the reactor, it should be considered that, the volume is typically increased due to release of a gas during calcination in general. For the two examples calcination of limestone (CaCO₃) to yield calcium oxide (CaO) and calcination of MgCO₃ to yield MgO, CO₂ is released. The design of the reactor and the surrounding devices should take into account the volume expansion. The design of the reactor with a cyclone near and/or around a plasma torch can give a rapid heating of the material to be heat treated, which in turn gives a rapid reaction with a rapid volume expansion.

In one embodiment, the reactor is a calcination reactor. The reactor can be used for heat treating many different materials. The heat treatment can for instance be for the purpose of calcination, sintering or heating the material.

In the second aspect there is provided a heat treatment method, wherein a material is heat treated in a reactor, wherein the reactor is a cyclone reactor, wherein at least one volume (Vₕ) inside the reactor is heated by a plasma torch to a temperature of at least 3000° C., and wherein heat is transferred from at least one volume (Vₕ) to the material by at least thermal radiation.

In one embodiment, the material to be heat treated flows in a helical gas flow beginning at the top of the cyclone, the flow is created by at least one inlet nozzle in the upper half of the reactor, the inlet nozzle being directed tangentially in a circular cross section of the reactor.

In one embodiment, the material to be heat treated comprises CaCO₃. In another embodiment, the material to be heat treated comprises MgCO₃. In another embodiment, the material to be heat treated comprises Ca(OH)₂. In further embodiments, the material to be heat treated comprises at least one of CaCO₃, MgCO₃, Ca(OH)₂, metal oxides, lithium metal oxides, dolomite, kaolinite, clay minerals, clay, minerals, spodumene, iron, nickel, zeolites, cementitious materials, cement raw meal, cement, sand, crushed stone, silica-based material or mixtures thereof.

In one embodiment, the plasma comprises carbon dioxide. The use of carbon dioxide in the plasma torch gives advantages. The CO₂ in the plasma torch is dissociated into CO, O₂, and O at high temperatures such as 3000° C. The atoms and molecules will be recombined when the temperature drops. This gives a high-energy gas flow, in the order of 7-14 MJ/kg.

In one embodiment, the material is provided in particles comprising a core, said core comprising the material, said core being coated with an outer layer comprising smaller particles (P_{SMALL}), wherein the smaller particles (P_{SMALL}) have an average particle size in the interval 1-500 nm, wherein the average particle size is calculated according to ISO 9276-2:2014 using the moment notation starting from a particle size distribution measured according to ISO 13320:2020. The smaller particles (Pₛₘₐₗₗ) are not to be confused with the particles. The size of the particles includes the core and the layer of smaller particles (Pₛₘₐₗₗ). In one embodiment, the particles comprise a core of CaCO₃ to be heat treated, where the core is surrounded by a layer of small particles of hydrophobically modified SiO₂.

In one embodiment, the smaller particles (P_{SMALL}) Comprise at least one material selected from the group consisting of SiO₂, SiO₂ modified with at least one hydrophobic compound, graphite, graphite oxide, graphene oxide, and graphene.

In one embodiment, the heat treatment is at least one selected from calcination, sintering, and heating.

In one embodiment, the heating is utilized for heat storage, for instance for sensible heat storage.

In one embodiment, the material is cooled in a cooling chamber directly after exiting the reactor. By using a chamber for cooling after the reactor a very rapid cooling can be obtained, which is advantageous for many applications. In one embodiment, wherein a cooling chamber is connected in series after an outlet from the reactor.

In one embodiment, water is added in the reactor, preferably in gaseous phase. Water is suitably added in plasma gas either in liquid or in gaseous phase. In the reactor any water in liquid phase will quickly be transformed into gaseous phase. It has turned out that the presence of gaseous water in the reactor improves the heat transfer to the material to be heat treated.

In one embodiment, water is not only used as an additive to improve heat transfer. In one embodiment, water is the material to be heat treated. In one embodiment, the material to be heat treated in the reactor is water, and where the water at least partly forms oxygen and hydrogen during the heat treatment.

All embodiments disclosed herein can be freely combined with each other as long as they are not clearly contradictory.

### EXAMPLES

### Example 1

Calcination tests were carried out in an electric arc cyclone reactor of diameter 1.25 m and height 1.45 m. The plasma generator of net power 200 kW was placed vertically in the centre of the upper section of the reactor. The temperature in the plasma generator was at least 3000° C. The temperature in a volume in the cyclone reactor was not measured, but estimated to be around 3500° C. in all examples. CaCO₃ of average diameter 200 μm was fed axially into the electric arc calciner. The degree of calcination of the material was measured for different material outlet temperatures:

| Material Outlet | Degree of |
|---|---|
| Temperature | Calcination |
| 1000° C. | 82.1% |
| 1050° C. | 86.7% |
| 1100° C. | 96.2% |

### Example 2

Tests were carried out in an electric arc cyclone reactor of diameter 1.25 m and height 1.45 m. The plasma generator of total power 350 kW was placed vertically in the centre of the reactor. Cement raw meal comprising, silica, iron oxide and CaCO₃ of average diameter 8 μm was fed into axially into the electric arc calciner. The temperature and throughput of the material were measured:

| Material Outlet | Throughput of |
|---|---|
| Temperature | material |
| 1126° C. | 165 kg/h |
| 1212° C. | 50 kg/h |

### Example 3

Tests were carried out in an electric arc cyclone reactor of diameter 1.25 m and height 1.45 m. The plasma generator of net power 250 kW was placed vertically in the centre of the reactor. Magnesium silicate of average diameter 310 μm was fed into axially into the electric arc calciner. The temperature and throughput of the material were measured:

| Material Outlet | Throughput of |
|---|---|
| Temperature | material |
| 1040° C. | 113 kg/h |
| 1068° C. | 159 kg/h |

1. A reactor wherein the reactor is a cyclone reactor, and wherein at least one volume (Vh) inside the reactor is adapted to be heated by a plasma torch to a temperature of at least 3000° C., wherein the cyclone reactor comprises an upper part with a first diameter (D1), a middle part with a second diameter (D2) and a lower part with a third diameter (D3), wherein the second diameter (D2) is larger than the first diameter (D1) and larger than the third diameter (D3).

2. The reactor according to claim 1, wherein the at least one volume (Vₕ) is in the uppermost part of the reactor, wherein uppermost is in relation to the direction of gravity force.

3. The reactor according to claim 1, wherein the reactor is equipped with at least one inlet in the upper half of the reactor, and which inlet is directed tangentially in a circular cross section of the reactor.

4. The reactor according to claim 1, wherein the at least one volume (Vₕ) inside the reactor is adapted to be heated by a plasma torch to a temperature of at least 3250° C.

5. The reactor according to claim 1, wherein the reactor is equipped with at least one outlet in the lower half of the reactor, and the reactor is adapted so that the average temperature of the mixture of gas and particles in the outlet is not more than 1300° C.

6. The reactor according to claim 1, wherein the reactor is a calcination reactor.

7. The reactor according to claim 1, wherein a cooling cyclone is connected in series after an outlet from the reactor.

8. A heat treatment method, wherein a material is heat treated in a reactor according to claim 1, wherein the reactor is a cyclone reactor, wherein at least one volume (Vₕ) inside the reactor is heated by a plasma torch to a temperature of at least 3000° C., and wherein heat is transferred from the at least one volume (Vₕ) to the material by at least thermal radiation,
wherein the material is provided as particles with an average particle in the interval from, 5 to 2000 μm, preferably 10 to 1000 μm, wherein the average particle size is calculated according to ISO 9276-2:2014 using the moment notation starting from a particle size distribution measured according to ISO 13320:2020,
wherein the material flows in a helical gas flow beginning at the top of the cyclone, the flow is created by at least one inlet nozzle in the upper half of the reactor, the inlet nozzle being directed tangentially in a circular cross section of the reactor.

9. The heat treatment method according to claim 8, wherein the material comprises at least one selected from the group consisting of CaCO₃ and MgCO₃.

10. The heat treatment method according to claim 8, wherein the material comprises Ca(OH)₂.

11. The heat treatment method according to claim 8, wherein the plasma comprises at least one selected from the group consisting of carbon dioxide, air and superheated steam.

12. The heat treatment method according to claim 8, wherein the material is provided in particles comprising a core, said core comprising the material, said core being coated with an outer layer comprising smaller particles (P_{SMALL}) wherein the smaller particles (P_{SMALL}) have an average particle size in the interval 1-500 nm, wherein the average particle size is calculated according to ISO 9276-2:2014 using the moment notation starting from a particle size distribution measured according to ISO 13320:2020.

13. The heat treatment method according to claim 12, wherein the smaller particles (P_{SMALL}) comprise at least one material selected from the group consisting of SiO2, SiO2 modified with at least one hydrophobic compound, graphite, graphite oxide, graphene oxide, and graphene.

14. The heat treatment method according to claim 8, wherein the material is allowed to be cooled to a temperature of not more than 1400° C. at an outlet of the reactor.

15. The heat treatment method according to claim 8, wherein water is added in the reactor, preferably in gaseous phase.

16. The heat treatment method according to claim 8, wherein the heat treatment is at least one selected from calcination, sintering, and heating.

17. The heat treatment method according to claim 8, wherein the material is cooled in a cooling cyclone directly after exiting the reactor.

18-21. (canceled)
